(19) United States
(12) Patent Application Publication
(10) Pub. No.: US 2008/0181687 A1
(43) Pub. Date: Jul. 31, 2008

(54) FIXING DEVICE AND IMAGE FORMING APPARATUS

(75) Inventor: Masahiro ISHINO, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/873,519

(22) Filed: Oct. 17, 2007

(30) Foreign Application Priority Data
Jan. 30, 2007 (JP) 2007-019979

(51) Int. Cl. G03G 15/20

(52) U.S. Cl. 399/329; 399/333

(57) ABSTRACT

A fixing device includes a heating section, a fixing belt, a pressing section and a cooling section. The heating section includes a first layer which is partially deformed when the first layer is pressed and which is restored when the first layer is not pressed. The fixing belt includes a second layer which is partially deformed when the second layer is pressed and which is restored when the second layer is not pressed. The fixing belt is wound around the heating section. The pressing section forms a nip portion in conjunction with the heating belt and the fixing belt. A toner image on a recording sheet is fused and pressed onto the recording sheet at the nip portion. The cooling section cools the recording sheet. The separating section separates the recording sheet cooled by the cooling section from the fixing belt.

### CROSS-REFERENCE TO RELATED APPLICATIONS

This application is based on and claims priority under 35 USC 119 from Japanese Patent Application No. 2007-019979 filed Jan. 30, 2007.

### BACKGROUND

1. Technical Field

The present invention relates to a fixing device and an image forming apparatus.

2. Related Art

With the recent improvement in digitalization and high-definition image, a color image forming apparatus can provide a high-quality image. With the trend toward the high-definition image, the color image forming apparatus using an electrophotographic technology is deployed in a printing market or a photograph market.

### SUMMARY

According to an aspect of the invention, a fixing device includes a heating section, a fixing belt, a pressing section, a cooling section, a separating section. The heating section includes a first layer which is partially deformed when the first layer is pressed and which is restored when the first layer is not pressed. Heat is applied to the heating section. The fixing belt includes a second layer which is partially deformed when the second layer is pressed and which is restored when the second layer is not pressed. The fixing belt is wound around the heating section. The heat is conducted from the heating section to the heating belt. The pressing section forms a nip portion in conjunction with the heating belt and the fixing belt. A toner image on a recording sheet is fused and pressed onto the recording sheet at the pressing section. The cooling section cools the recording sheet, which has passed the nip portion, with the recording sheet being attached onto the fixing belt. The separating section separates the recording sheet cooled by the cooling section from the fixing belt.

### BRIEF DESCRIPTION OF THE DRAWINGS

An Exemplary embodiment of the present invention will be described in detail based on the following figures, wherein:

FIG. 1 is a side sectional view illustrating a configuration of a fixing device according to an exemplary embodiment;

FIG. 2 is a sectional view of a heating roll alone;

FIG. 3 is a sectional view of the fixing belt 13 alone;

FIG. 4 is a schematic sectional view illustrating the sheet P;

FIG. 5 is a transverse cross sectional view illustrating a heating roll, the fixing belt, and the sheet P in a nip portion;

FIG. 6 is a transverse cross sectional view illustrating a cooling unit, the fixing belt, and the sheet P; and

FIG. 7 is a block diagram illustrating a configuration of an image forming apparatus using the fixing device.

### DETAILED DESCRIPTION

Hereinafter, an exemplary embodiment of the present invention will be described with reference to the attached drawings.

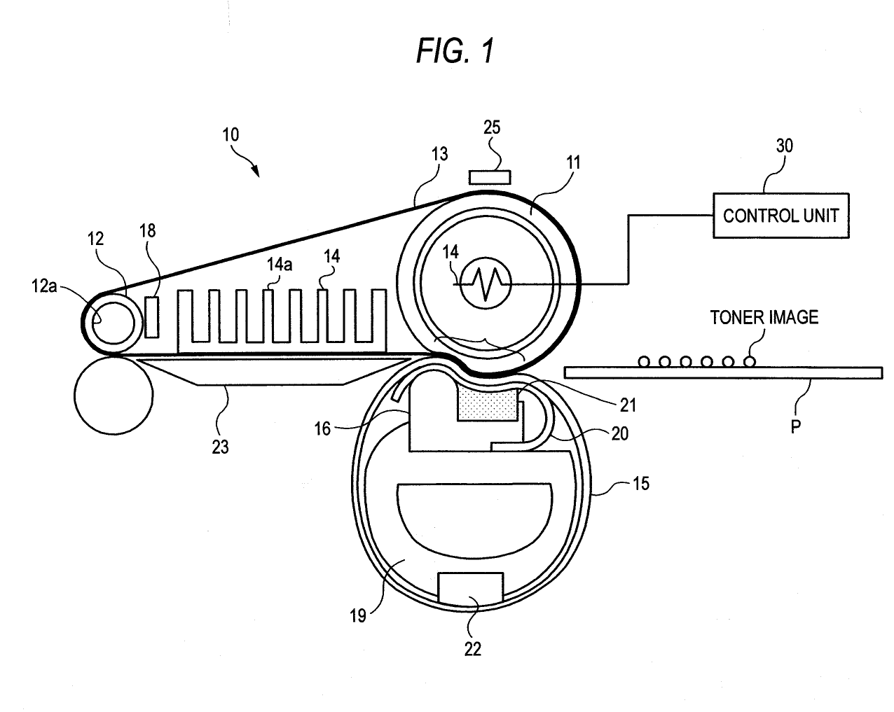

FIG. 1 is a side sectional view illustrating a configuration of a fixing device 10 according to an exemplary embodiment.

As shown in FIG. 1, the fixing device 10 includes a heating roll (heating section, rotating section) 11 which is disposed on an upstream side in a transport direction of a sheet (recording sheet) P, a separating roll (separating section, separating portion) 12 which is disposed on a downstream side in the transport direction of the sheet, a fixing belt 13 which is wound around the heating roll 11 and the separating roll 12, a cooling unit 14 which is disposed in a position surrounded with the fixing belt 13 and is disposed between the heating roll 11 and the separating roll 12, a pressing belt (pressing section) 15 opposed to the heating roll 11, a pressurizing pad (pressing portion, pressing section, hard pad) 16 which is disposed in an inner peripheral surface of the pressing belt 15 and is pressed from the heating roll 11 between the pressing belt 15. A fusing press zone includes the heating roll 11, the fixing belt 13, the pressing belt 15, and the pressurizing pad 16. A cooling portion includes the separating roll 12 and the cooling unit 14. A blast machine (not shown) may be attached as the cooling portion.

The heating roll 11 is rotatably supported and is a cylindrical roll, which rotates at a predetermined surface speed. In an inside of the heating roll 11, as a heating source, for example, a halogen heater 17 having a 600 W is disposed. A toner image formed on a sheet P is heated with the heat of the halogen heater 17. On the other hand, a temperature sensor 18 is disposed on a surface of the separating roll 12. The temperature sensor 18 detects a surface temperature of the separating roll 12 and outputs the surface temperature of the separating roll 12 to a control unit 30.

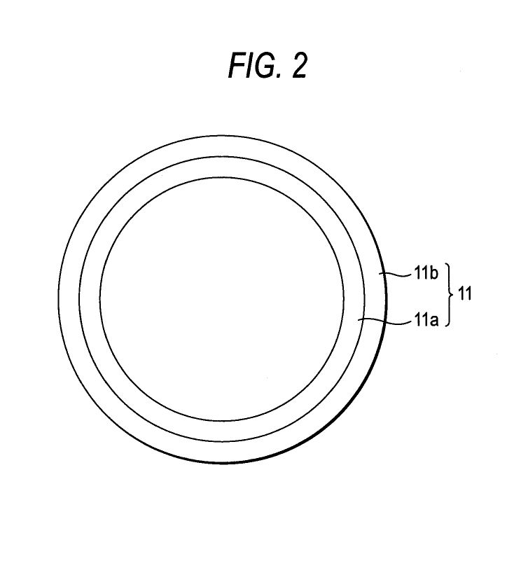

Herein, FIG. 2 is a sectional view illustrating heating roll 11 alone.

As shown in FIG. 2, the heating roll 11 includes a cored bar (metal core) 11a which forms a roll body and an elastic layer (first layer) 11b which is formed on a circumferential surface of the cored bar 11a. The cored bar 11a is made of steel material and has a thickness of 0.5 mm. The elastic layer 11b is made of silicone rubber and a thickness T_{11b} of the elastic layer 11b is 0.3 mm. The elastic layer 11b is a layer (deformable layer) having a feature that the elastic layer 11b is partially deformed when pressed and is restored to a before-deformation state when not pressed.

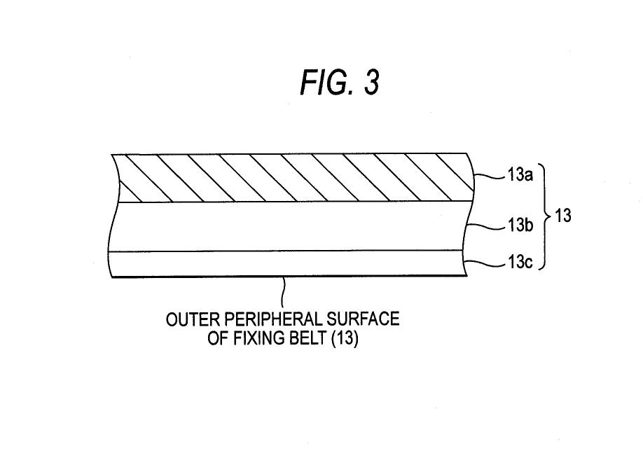

FIG. 3 is a sectional view illustrating the fixing belt 13 alone.

As shown in FIG. 3, the fixing belt 13 includes a belt base material 13a which constitutes a belt body, an elastic layer (second layer) 13b which is formed on a surface of the belt base material 13a, a release layer 13c which is formed on an outer side of the elastic layer 13b as an outermost layer. The fixing belt 13 is an endless belt without nay joint. In addition, the fixing belt 13 is disposed through the heating roll 11 and the separating roll 12 and rotates corresponding to a rotating operation of the heating roll 11. The elastic layer 13b is a layer (deformable layer) having a feature that the elastic layer 13b is partially deformed when pressed and is restored to a before-deformation state when not pressed.

The belt base material 13a is made of a heat resistance resin such as polyimide and polyamide or metal material such as nickel and aluminum. In the exemplary embodiment, a polyimide resin having a thickness of 100 μm (0.1 mm) is used as the belt base material 13a. The elastic layer 13b is, for example, made of silicone rubber material and a thickness T_{13b} of the elastic layer 13b is 0.3 mm. The release layer 13c serves to enhance a release characteristic from the sheet P, which is a fluorine resin having a thickness of 10 μm (0.01 mm). That is, in the exemplary embodiment, a thickness of the fixing belt 13 is a 0.41 mm.

An outer peripheral surface (specifically, a surface of the release layer 13c) of the fixing belt 13 may be a smooth surface (close to a mirror surface).

As mentioned above, the thickness T_{13b} of the elastic layer 13b of the fixing belt 13 is equal to thickness T_{11b} of the elastic layer 11b of the heating roll 11 (T_{13b}=T_{11b}=0.3 mm). However, in the fixing belt 13, it is possible that the thickness T_{13b} of the elastic layer 13b is thinner than the thickness T_{11b} of the elastic layer 11b (T_{13b}<T_{11b}). That is, the elastic layer 13b of the fixing belt 13 has the same thickness of the elastic layer 11b of the heating roll 11 or is thinner than that of the elastic layer 11b.

Returning to FIG. 1, the description will be continued.

The separating roll 12 is a roll for placing the fixing belt 13 thereon with the belt curved in a predetermined curvature, thereby promoting the separation of the sheet (object for fixing) P transported to the fixing belt 13 with the sheet P being attached onto the fixing belt 13. The separating roll 12 is a tubular section having an inner space (ventilation duct) 12a and is made of metal material such as aluminum and SUS (stainless steel). The separating roll 12 is rotatably supported by a rotating section in a supporting frame (not shown) and is elastically biased in a direction for applying a tension to the fixing belt 13 by a known tension applying mechanism made of a spring, or the like.

A sheet guide 23 is disposed so that the fixing belt 13 is opposed between the heating roll 11 and the separating roll 12. The sheet P which is transported with a close contact to the fixing belt 13 and progresses between the fixing belt 13 and the sheet guide 23.

A temperature sensor 25 is disposed in the vicinity of a portion of the fixing belt 13 which is wound around the heating roll 11. The temperature sensor 25 serves to detect a surface temperature of the fixing belt 13 and outputs the detected temperature to the control unit 30. The control unit 30 controls the halogen heater 17 based on a detected result of the temperature sensors 18 and 25.

The cooling unit 14 forcibly cools an inner peripheral surface side from the heating roll 11 of the fixing belt 13 to the separating roll 12 and is formed so that plural of fins 14a disposed in a heat release side extend in a width direction of the fixing belt 13.

The pressing belt 15 is an endless belt without any joint and is rotatably supported by the pressurizing pad 16 disposed in the pressing belt 15, a guide section 19, and a belt regulation control section (not shown) disposed in both end portions of the pressing belt 15. The pressing belt 15 is disposed so as to be pressed to the heating roll 11 in a nip portion N, and follows the rotation of the fixing belt 13. Additionally, the nip portion N is formed in which the pressing belt 15 winds around the heating roll 11 between the fixing belt 13 and the sheet P passes between the fixing belt 13 and the pressing belt 15.

Herein, the pressing belt 15 is supported to the pressurizing pad 16 and the guide section 19 in an area other than both ends of the pressing belt 15 in a width direction. In an area other than both ends of the pressing belt 15, the inner peripheral surface of the pressing belt 15 rotates while making sliding contact with a slide maintaining sheet (low friction sheet) 20 which is disposed so as to cover the pressurizing pad 16 and the guide section 19, and the guide section 19.

The pressurizing pad 16 is disposed inside the pressing belt 15 so as to be supported by the guide section 19. The pressurizing pad 16 is pressed against the heating roll 11 with the pressing belt 15 being disposed therebetween and forms the nip portion N between the fixing belt 13 and the heating roll 11. The pressurizing pad 16 has a soft pad (pressing portion and pressing section) 21 disposed in an input port (upstream side) of the nip portion N. The pressurizing pad 16 locally presses a surface of the heating roll 11 in an output port (downstream side) of the nip portion N so that a surface of the toner image is made smooth and an image gloss is applied.

In the pressing belt 16, in order to decrease a slide resistance between the inner peripheral surface of the pressing belt 15 and the pressurizing pad 16, a slide maintaining sheet 20 is provided as an example of the slide friction section in a surface which comes in contact with the pressing belt 15. The slide maintaining sheet 20 is interposed therebetween the pressurizing pad 16 and the inner peripheral surface of the pressing belt 15 in a whole area of the nip portion N.

A lubricant agent impregnation section (oil impregnation felt) 22 is disposed in the guide section 19, which extends in a longitudinal direction of the fixing device 10. The lubricant agent impregnation section 22 is disposed so as to be contacted with the inner peripheral surface of the pressing belt 15, which properly supplies the lubricant agent. With such a configuration, the lubricant agent is supplied in a moving portion between the pressing belt 15 and the slide maintaining sheet 20 so that a movement resistance between the pressing belt 15 disposed between the slide maintaining sheet 20 and the pressurizing pad 16 reduces, thereby increasing a smooth rotation movement of the pressing belt 15. Accordingly, the lubricant agent may have an effect that supplies abrasion of the inner peripheral surface of the pressing belt 15 and the surface of the slide maintaining sheet 20.

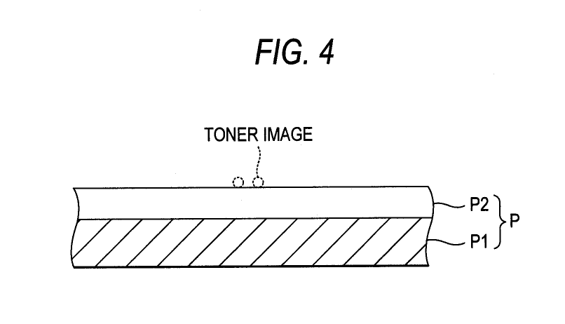

FIG. 4 is a schematic sectional view illustrating the sheet P.

As shown in FIG. 4, the sheet P uses material which laminates a transparent resin P2 mainly made of a thermoplastic resin in a base material P1. As the base material P1, a normal sheet for an image forming, a coated paper, a developing paper, and the like are used. As the thermoplastic resin forming the layer of the transparent resin P2, a polyethylene resin, and a styrene-acrylic ester resin are used. The layer of the transparent resin P2 may be fused with heat and pressure at the time of being fixed and is formed into a layer having a thickness in which the toner image can be buried into the resin P2.

The sheet P is not limited, when the sheet P can be applicable to the image forming apparatus. Since an image of a photograph having good gloss is obtained using the fixing device 10, the sheet P shown in FIG. 4 may be used.

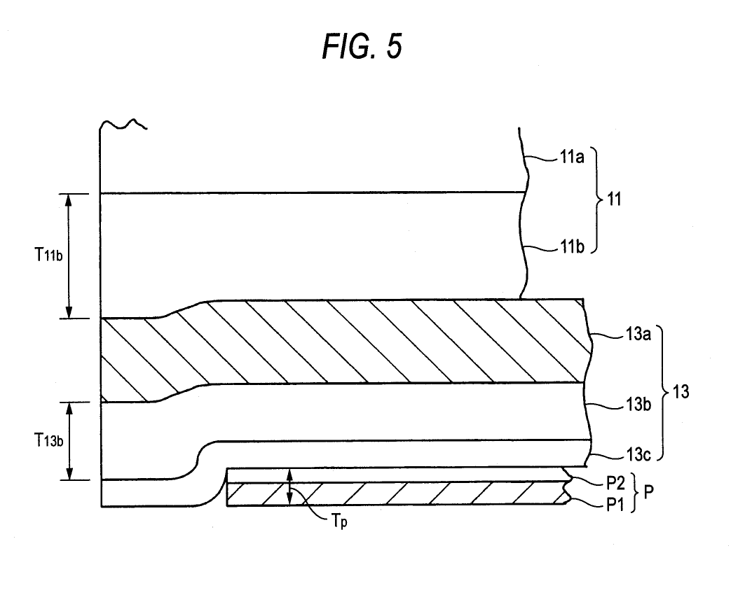

FIG. 5 is a transverse cross sectional view illustrating the heating roll 11, the fixing belt 13, and the sheet P in the nip portion (see FIG. 1 for reference). That is, FIG. 5 is the transverse cross sectional view of respective configuration sections, which illustrates a fusing press zone in which a toner image on the sheet P is fused with heat and pressed and fixed onto the sheet P.

As shown in FIG. 5, when the sheet P enters the nip portion N, the elastic layer 13b of the fixing belt 13 and the elastic layer 11b of the heating roll 11 vary. In other words, a thickness Tₚ of the sheet P varies corresponding to the variation of the two elastic layers 13b and 11b in the nip portion N. That is, a thickness of the deformed area which is deformed corresponding to the thickness Tₚ of the sheet P is 0.6 mm in the nip portion. When a thickness of the deformed area is 0.6 mm, it is possible to correspond to a thick sheet.

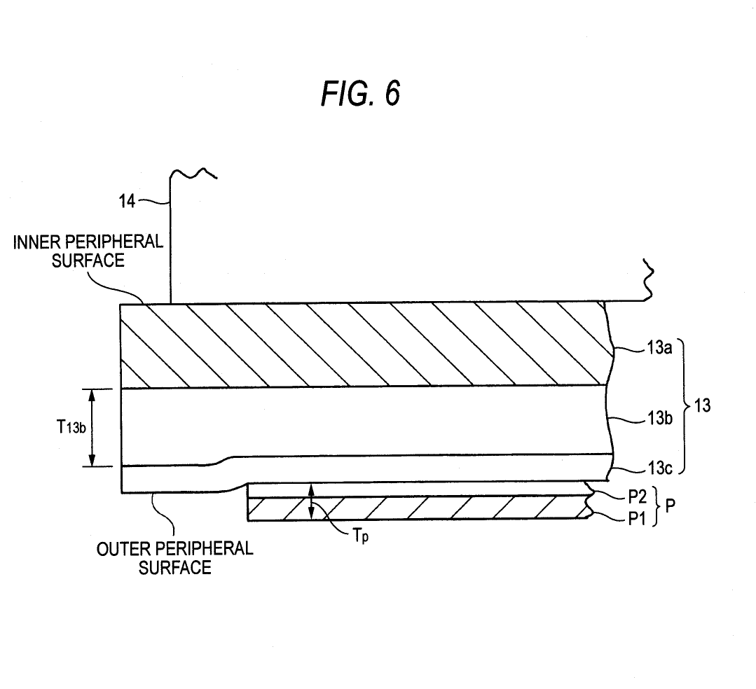

FIG. 6 is a transverse cross sectional view illustrating a cooling unit 14, the fixing belt 13, and the sheet P. FIG. 6 is the transverse cross sectional view illustrating the configuration sections in a cooling zone cooling the sheet P in a state where the sheet P is attached onto the fixing belt 13.

As shown in FIG. 6, when the fixing belt 13 passes the nip portion N with the sheet P, the sheet P adheres to an outer peripheral surface of the fixing belt 13. The fixing belt 13 cools by the cooling unit 14 which is disposed in the inner peripheral side of the fixing belt 13. That is, the heat of the sheet P is transferred to the cooling unit 14 through the fixing belt 13. With such a configuration, the smaller the thickness of the fixing belt 13 is thin, the greater the cooling efficiency of the fixing belt 13 is obtained. The smaller the thickness T_{13b} of the elastic layer 13b of the fixing belt 13 is thin, the greater the cooling efficiency of the fixing belt 13 is obtained.

The sheet P cools and is surrounded by the elastic layer 13b which is a deformed state so as not to generate a gloss stain on the image surface. That is, the sheet P cools in which the image surface of the sheet P extends to a whole surface in a state where the sheet P is attached onto the surface of the fixing belt 13.

The sheet P which adheres to the fixing 13 cooled by the cooling unit 14 is bent by the separating roll 12 in a predetermined curvature so that the sheet P is separated from the fixing belt 13. At this time, the smaller the thickness of the fixing belt 13, the smaller a radius of curvature the outer peripheral surface of the fixing belt 13 is obtained. The smaller the thickness T_{13b} of the elastic layer 13b of the fixing belt 13 is thin, the smaller the radius of curvature the outer peripheral surface of the fixing belt 13 is obtained.

With such a configuration, in the exemplary embodiment, as the elastic layer of the nip portion N, the elastic layer 11b of the heating roll 11 and the elastic layer 13b of the fixing belt 13 can be used (T_{11b}+T_{13b}). As an elastic layer at the time of being cooled with the cooling device 14, the elastic layer 13b of the fixing belt 13 can be used (T_{13b}). As the elastic layer when the sheet P is separated from the fixing belt 13, the elastic layer 13b of the fixing belt 13 can be used (T_{13b}).

The elastic layer 11b of the heating roll 11 and the elastic layer 13b of the fixing belt 13 have the same a thermal conductivity. A thermal conductivity of the elastic layer 11b of the heating roll 11 is greater than that of the elastic layer 13b of the fixing belt 13. A thermal conductivity is a value of a material that indicates its ability to conduct heat. A thermal conductivity of a silicone rubber is in the range of 0.167 to 0.149 W/m·k. Additionally, the thermal conductivity can be varied using a filler which is mixed into the silicone rubber when manufactured.

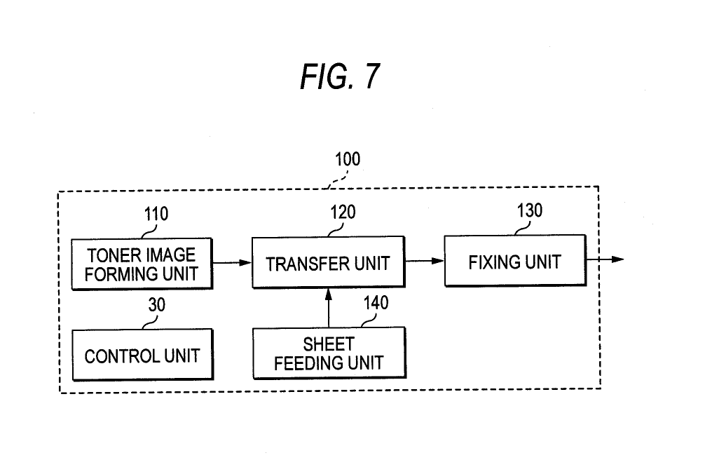

FIG. 7 is a block diagram illustrating a configuration of an image forming apparatus 100 using the fixing device 10.

The fixing device 10 according to the above-mentioned exemplary embodiment is used as the image forming apparatus 100 using an electrophotography type such as a duplicator, printer, facsimile, a machine for a combination the above-mentioned machines. The image forming apparatus 100 shown in FIG. 7 includes toner image forming unit 110 for forming a toner image, transfer unit 120 for transferring the toner image formed by the toner image forming unit 110 on the sheet P, fixing unit 130 for fixing the toner image transferred on the sheet P, and sheet feeding unit 140 for feeding the sheet P to the transfer unit 120 in a predetermined timing. As the fixing unit 130, the fixing device 10 according to the exemplary embodiment can be used. Any configuration other than the fixing device 10 is usable as long as it is agreeable with the object of the invention. The toner image forming unit 110 includes an electrostatic latent forming unit which forms an electrostatic latent image on an image holding unit and a developing unit which develops the electrostatic latent image using the toner.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a heating section that includes a first layer which is partially deformed when the first layer is pressed and which is restored when the first layer is not pressed, the heating section to which heat is applied;
a fixing belt that includes a second layer which is partially deformed when the second layer is pressed and which is restored when the second layer is not pressed, the fixing belt which is wound around the heating section and to which the heat is conducted from the heating section;
a pressing section that forms a nip portion in conjunction with the heating belt and the fixing belt, at which a toner image on a recording sheet is fused and pressed onto the recording sheet;
a cooling section that cools the recording sheet, which has passed the nip portion, with the recording sheet being attached onto the fixing belt; and
a separating section that separates the recording sheet cooled by the cooling section from the fixing belt.

2. The fixing device according to claim 1,
wherein a thickness of the second layer is equal to or smaller than that of the first layer.

3. The fixing device according to claim 1,
wherein a thermal conductivity of the first layer is equal to or greater than that of the second layer.

4. The fixing device according to claim 1,
wherein the heating section includes a metal core, and
the first layer of the heating section is formed on a circumferential surface of the metal core forming a body of the heating section.

5. The fixing device according to claim 1,
wherein the heating section includes a release layer and a base material, and
the second layer of the fixing belt is disposed between the release layer forming an outermost layer of the heating section and the base material of the fixing belt.

6. A fixing device comprising:
a heating section that includes a first layer which is partially deformed when the first layer is pressed and which is restored when the first layer is not pressed, the heating section to which heat is applied;
a fixing belt that includes a second layer which is partially deformed when the second layer is pressed and which is restored when the second layer is not pressed, the fixing belt which (i) passes through a fusing press zone where a toner image on a recording sheet is fused and pressed onto the recording sheet and (ii) passes through a cooling zone where the recording sheet attached to the fixing belt, and the fixing belt which is wound around the heating section; and
a separating section that separates the recording sheet attached onto the fixing belt from the fixing belt.

7. The fixing device according to claim 6,
wherein a thickness of the second layer is equal to or smaller than that of the first layer.

8. The fixing device according to claim 6,
wherein the heating section comprises a heating roll.

9. A fixing device comprising:
a fusing press section that includes a nip portion formed between (i) a fixing belt which is wound around a heating section and which receives heat from the heating section and (ii) a pressing section pressed by the fixing belt, the fusing press section, when the recording sheet passes the nip portion, fuses a toner image on a recording sheet with heat applied from the fixing belt and press the toner image onto the recording sheet;
a cooling section that cools the recording sheet attached onto the fixing belt with the recording sheet being attached onto the fixing belt when the toner image is fused and pressed by the fusing press section; and
a separating section that separates the recording sheet cooled by the cooling portion from the fixing belt,
wherein deformable layers, which is partially deformed when a deformable layer is pressed and which is restored when the deformable layer is not pressed, is provided in the fusing press section and the cooling section, respectively.

10. The fixing device according to claim 9,
wherein the cooling section is disposed in an inner peripheral surface side of the fixing belt.

11. An image forming apparatus comprising:
a toner image forming section that forms a toner image;
a transfer section that transfers the toner image formed by the toner image forming section on a recording sheet;
a fixing section that fixes the toner image transferred on the recording sheet onto the recording sheet;
a heating section that includes a first layer which is partially deformed when the first layer is pressed and which is restored when the first layer is not pressed, the heating section to which the heat is applied;
a fixing belt that includes a second layer which is partially deformed when the second layer is pressed and which is restored when the second layer is not pressed, the fixing belt which is wound around the heating section and to which the heat is conducted from the heating section;
a pressing section that forms a nip portion in conjunction with the heating section and the fixing belt, at which a toner image on a recording sheet is fused and pressed onto the recording sheet;
a cooling section that cools the recording sheet, which passes the nip portion, with the recording sheet being attached onto the fixing belt; and
a separating section that separates the recording sheet cooled by the cooling portion from the fixing belt.
